(19) United States
(12) Patent Application Publication
(10) Pub. No.: US 2005/0012619 A1
(43) Pub. Date: Jan. 20, 2005

(54) Large array of radio frequency ID transponders deployed in an array by use of deploying rows of transponders that unwind from long spools of high strength fibre or tape with passive RFID transponders separated by fixed lengths

(76) Inventor: Kimihiko Ernst Sato, Toronto (CA)

Correspondence Address: NIELDS & LEMACK, 176 EAST MAIN STREET, SUITE 7, WESTBORO, MA, 01581, US

(21) Appl. No.: 10/858,585

(22) Filed: Jun. 2, 2004

(30) Foreign Application Priority Data
Jun. 6, 2003 (CA) 2,430,242

(51) Int. Cl. G08B 13/14

(52) U.S. Cl. 340/572.8

(57) ABSTRACT

Large array of radio frequency ID transponders deployed in an array by use of deploying rows of transponders that unwind from long spools of high strength fibre or tape with passive RFID transponders separated by fixed lengths

### FIELD OF THE INVENTION

This invention relates to the field of proximity information acquisition of mobile objects inside of a delineated space, and in a method of deploying a large array of passive low cost radio frequency identification transponders around a large delineated space.

### DESCRIPTION OF PRIOR ART

Radio Frequency Identification (RFID) is a fairly well understood technology where a small low cost radio device, responds to a nearby low power radio based reader device. The location of the reader device and this proximity information, when used in conjunction with the location and proximity information from other low power reader devices allows for position and velocity information to be ascertained. Many variants of this technology exist where the mobile transponder may be active, meaning they contain a power source, or may be passive, meaning that they transmit using power received from the radio antenna. Recent additions to the technology allows for multiple transponders in the same vicinity to be queried in turn, allowing for entire pallets of goods containing multiple transponders to be scanned and recorded quickly and accurately. Low cost transponders allow for virtually disposable transponders where the recovery of the transponders after use is not necessary. Tamper proof transponders are available as well, such as used for house-arrest ankle bracelets monitors.

In passive positioning the mobile object itself listens for positioning information such as using ground based radio beacons or satellite signals. It then informs a central information collection authority of this information. An example of such a system is the LORAN positioning system used in commercial aviation that uses the direction of two or more beacons from the mobile object to ascertain the location of the object. A second example of passive positioning is the use of Global Positioning System (GPS) signals from a constellation of orbiting satellites where high accuracy timing information is received from multiple satellites in order to calculate the exact position of the receiver. Velocity information can be ascertained using successive positioning measurements over time.

### SUMMARY OF THE INVENTION

According to the invention, there is provided a method and device compromising:
The method of deploying a long row of passive low-cost radio frequency identification (RFID) transponders by using reels of fibre or tape containing transponders separated by fixed lengths.
The method of deploying parallel rows of these rows of transponders in order to deploy a large array of equally spaced passive low-cost RFID transponders.
The apparatus of these reels of fibre or tape containing these passive low-cost RFID transponders.

Advantageously, the system and apparatus according to the invention allows:
A method for an inexpensively and quickly deploying a lot of passive low-cost RFID transponders in a grid. This allows for a positioning system within the delineated space that can be quickly deployed in times of crisis as part of a disaster rescue or recovery operation, as part of a crime scene investigation, as part of automobile race or athletic event telemetry, as part of tracking mobile objects at an airport, port, hospital, motion picture set location.
More accurate positioning with less time per position measurement than the use of Global Positioning System (GPS) satellites.
Additionally, the system can be deployed underground, which is not possible with the use of GPS.

### BRIEF DESCRIPTION OF THE DRAWINGS

FIG. 1 illustrates an apparatus according to an embodiment of the invention.

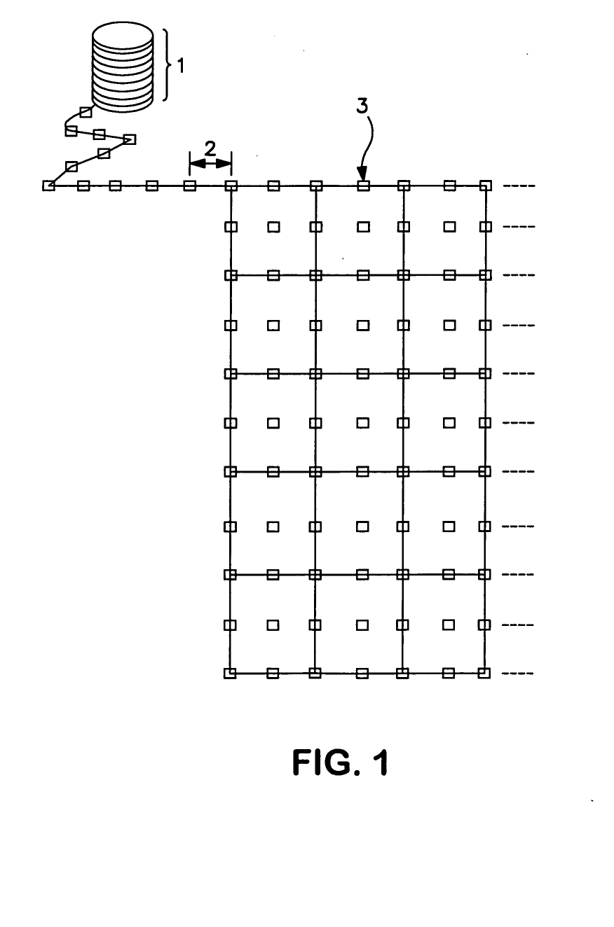

### DESCRIPTION OF THE PREFERRED EMBODIMENTS

Passive RFID transponders are inexpensive enough to be disposable. In cases where there are few objects to be tracked, but the area to be tracked cannot be adequately covered due to distance or due to environment by RFID reader devices, this alternative allows for the reader device to reside on the mobile object itself. The large grid of RFID tags accurately position the mobile object. The accuracy of this positioning is a factor of the separation distance of the RFID tags in the array. Individually placing each tag is laborious and time consuming. The innovation of this patent is to place RFID transponders within a strong fibre or tape, which is wound up in a reel or spool and separated by accurate fixed distance.

This allows for large rows or arrays of RFID passive low-cost transponders to be deployed quickly and accurately.

The fibre can be similar to the high strength polyester fibre used in fishing lines, or range to using high tensile strength Kevlar rope. When used as a tape, the same durable tape used on highways for temporary lines can be used.

These tags can be deployed in a temporary fashion, for use in disaster site positioning, or in a permanent fashion, which can be used in marking farmer's fields or airport runway locations. In the case that the temporary deployments are such that recovering the deployment is not possible, but the environmental impact of such deployment needs to be minimized, the fibre or tape can be made of strong biodegradable substances.

1. An apparatus consisting of the following components:
A reel or spool of fibre or tape which has embedded within it a low-cost passive radio frequency identification (RFID) transponders separated by accurate measured distances along the fibre or tape.

2. The combination defined in claim 1, wherein the material for the fibre or tape has high impact durability.

3. The combination defined in claim 1, wherein the material for the fibre or tape has biodegradability.

4. The combination defined in claim 1, wherein the material for the fibre or tape has luminescent or fluorescent qualities, allowing for it to be easily seen in the dark.

5. The combination defined in claim 1, wherein the material for the fibre or tape has additionally contains fibre optic cable, wires or conductive elements allowing for future data transmission through the fibre or tape.
